(19) United States
(12) Patent Application Publication
(10) Pub. No.: US 2011/0252256 A1
(43) Pub. Date: Oct. 13, 2011

(54) METHODS, SYSTEMS, AND COMPUTER PROGRAM PRODUCTS FOR MANAGING AN IDLE COMPUTING COMPONENT

(76) Inventor: Robert Paul Morris, Raleigh, NC (US)

(21) Appl. No.: 12/758,125

(22) Filed: Apr. 12, 2010

(51) Int. Cl. G06F 1/32; G06F 3/048

(52) U.S. Cl. 713/323; 715/764

(57) ABSTRACT

Methods and systems are described for managing an idle computing component. In one aspect, an idle period is detected for an addressable entity included in an application process and stored in a processor memory defined by an address space of an IPU in an application process. The addressable entity is not accessed by an IPU for executing during the idle period. A determination is made that specified idle condition is met for the idle period. The addressable entity is removed from the processor memory in response to the determination that the idle condition is met.

### BACKGROUND

Current energy management systems in some computing devices can detect when a device is idle by detecting no user input over a given time period. In response, some systems change the power state of an entire device by entering a low power state referred to as “suspending” the device or putting the device to “sleep.” Some operating systems allow a user to place a device in hibernate mode. In hibernation, the current state of the system is copied from the device's processor memory to persistent storage, such as a hard drive. The device is subsequently powered down. A device in hibernate mode may be restarted to restore the saved system state instead of performing a fresh boot.

These solutions do not address energy management while a user is actively using a device. A look at process activity on many devices reveals that many if not most processes are using little, if any, processor time although they typically are using other system resources that require energy and have other costs. Some of these processes and/or included threads are included in operating system and/or service processes that provide services to one or more applications. A network stack and antivirus monitor are examples. Such service processes rarely have active user interfaces presented on a display, audio, and/or other output device for presentation to a user. Processes with active user interfaces visible or otherwise detectable to a user are typically processes under control of a user. Users are left with the decision of whether to leave such processes and/or their included threads and components active or not. Processes, with active user interfaces, that are neglected by users may utilize energy as well as other resources unnecessarily.

Current systems can detect non-responsive user interface elements. Non-responsive interface elements are presented by processes that are blocked and/or too busy to process detected user input for the application process via the user interface of the application process. Non-responsive user interface elements and application processes are identified in current systems in response to detecting user input corresponding to the user interface elements for processing by their respective application processes.

Accordingly, there exists a need for methods, systems, and computer program products for managing an idle computing component.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for managing an idle computing component. In one aspect, the method includes detecting an idle period, for a first addressable entity in an application process presenting a user interface element via an output device, during which the first addressable entity, stored in a processor memory defined by an address space of an IPU, is not accessed by the IPU in the application process. The method further includes determining a specified idle condition is met for the idle period. The method still further includes in response to determining the idle condition is met, removing the first addressable entity from the processor memory.

Further, a system for managing an idle computing component is described. The system includes an execution environment including an instruction-processing unit configured to process an instruction included in at least one of an idle monitor component, an idle policy component, and a policy agent component. The system includes the idle monitor component configured for detecting an idle period, for a first addressable entity in an application process presenting a user interface element via an output device, during which the first addressable entity, stored in a processor memory defined by an address space of an IPU, is not accessed by the IPU in the application process. The system further includes the idle policy component configured for determining a specified idle condition is met for the idle period. The system still further includes the policy agent component configured for, in response to determining the idle condition is met, removing the first addressable entity from the processor memory.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for managing an idle computing component according to an aspect of the subject matter described herein;

FIG. 3 is a block diagram illustrating an arrangement of components for managing an idle computing component according to another aspect of the subject matter described herein;

FIG. 4a is a block diagram illustrating an arrangement of components for managing an idle computing component according to another aspect of the subject matter described herein;

FIG. 4b is a block diagram illustrating an arrangement of components for managing an idle computing component according to another aspect of the subject matter described herein;

FIG. 5a is a diagram illustrating a user interface presented via a display device according to an aspect of the subject matter described herein; and

FIG. 5b is a diagram illustrating a user interface presented via a display device according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

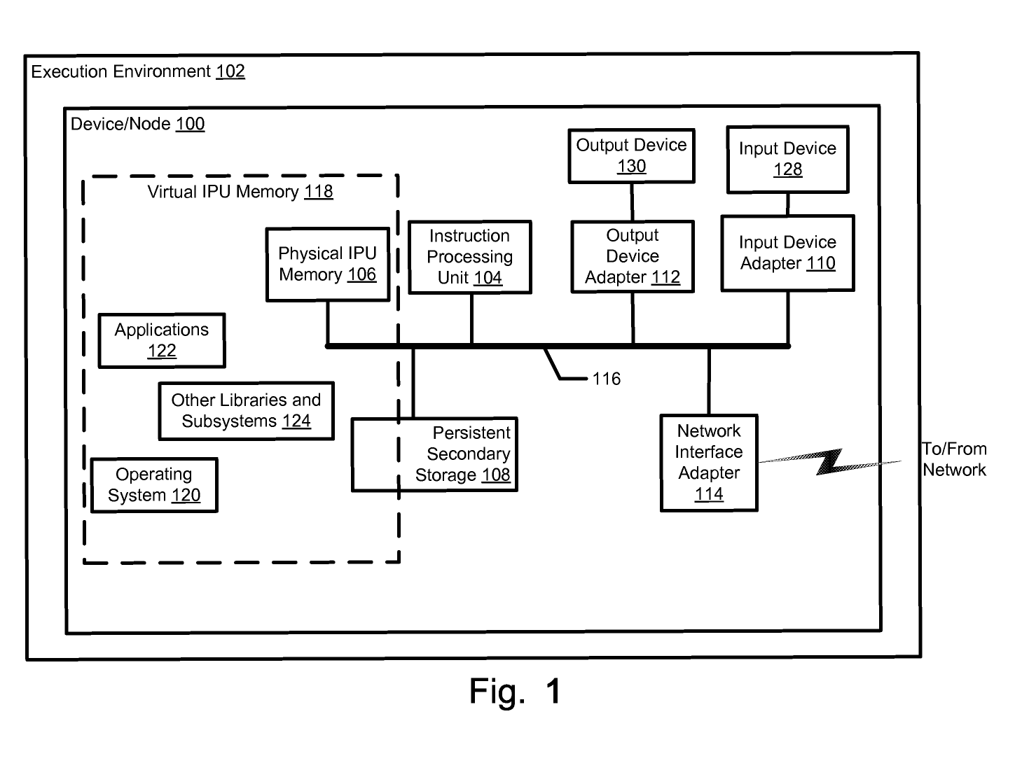

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein.

An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, hand-held and other mobile devices, multiprocessor devices, distributed devices, consumer electronic devices, and/or network-enabled devices. Those skilled in the art will understand that the components illustrated in FIG. 1 are exemplary and may vary by particular execution environment

FIG. 1 illustrates hardware device 100 included in execution environment 102. Hardware device 100 as illustrated includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSP), graphics processing units (GPU), application-specific integrated circuits (ASIC), and/or field programmable gate arrays (FPGA). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space define a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Various types of memory technologies may be included in physical processor memory 106. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one more magnetic disk drives, and/or one or more optical disk drives. Persistent secondary storage may include removable media. The drives and their associated computer-readable storage media provide volatile and/or nonvolatile storage for computer readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, other program code and/or data components illustrated by other libraries and subsystems 124. In an aspect, some or all software components may be stored in locations accessed by IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a context of a process. A process may include one or more threads. A thread includes a sequence of instructions executed by IPU 104 in a thread context. The terms “thread” and “process” may be used interchangeably herein when a process includes only one thread. Program code for a particular application and/or service may be executed in one or more processes. A process including application code is referred to herein as an “application process.”

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interfaces. The terms communication interface and network interface are used interchangeably. FIG. 1 illustrates network interface adapter 114 as a network interface included in execution environment 102 to operatively couple device 100 to a network. The terms network node and node in this document both refer to a device having a network interface for operatively coupling the device to a network.

Exemplary network interfaces include wireless network adapters and wired network adapters. Exemplary wireless networks include a BLUETOOTH network, a wireless 802.11 network, and/or a wireless telephony network (e.g., a cellular, PCS, CDMA, and/or GSM network). Exemplary wired networks include various types of LAN, WANS, and personal area networks (PANs). Exemplary network adapters for wired networks include Ethernet adapters, Token-ring adapters, FDDI adapters, asynchronous transfer mode (ATM) adapters, and modems of various types. Exemplary networks also include intranets and internets such as the Internet.

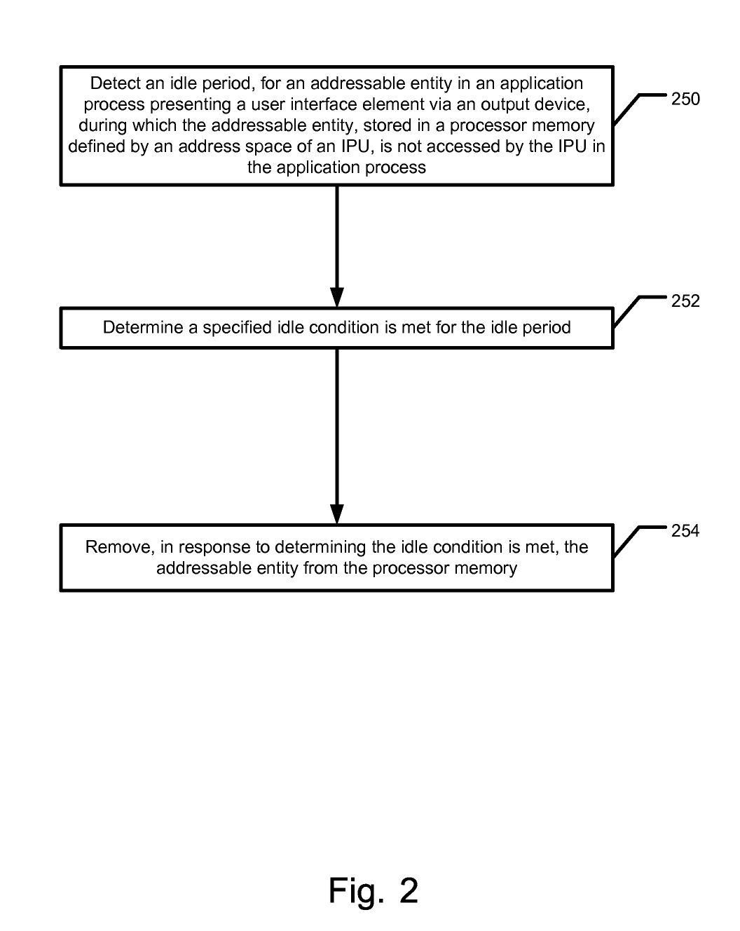

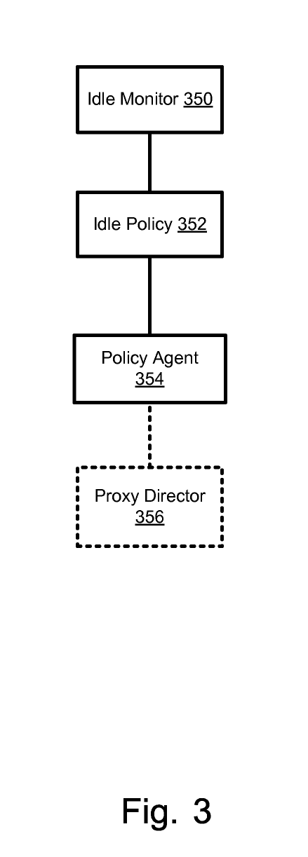

FIG. 2 is a flow diagram illustrating a method for managing an idle computing component according to an exemplary aspect of the subject matter described herein. FIG. 3 is a block diagram illustrating a system for managing an idle computing component according to another exemplary aspect of the subject matter described herein. A system for managing an idle computing component includes an execution environment, such as execution environment 102 in FIG. 1, including an instruction-processing unit, such as IPU 104, configured to process an instruction included in at least one of idle monitor component 350, idle policy component 352, and policy agent component 354 illustrated in FIG. 3.

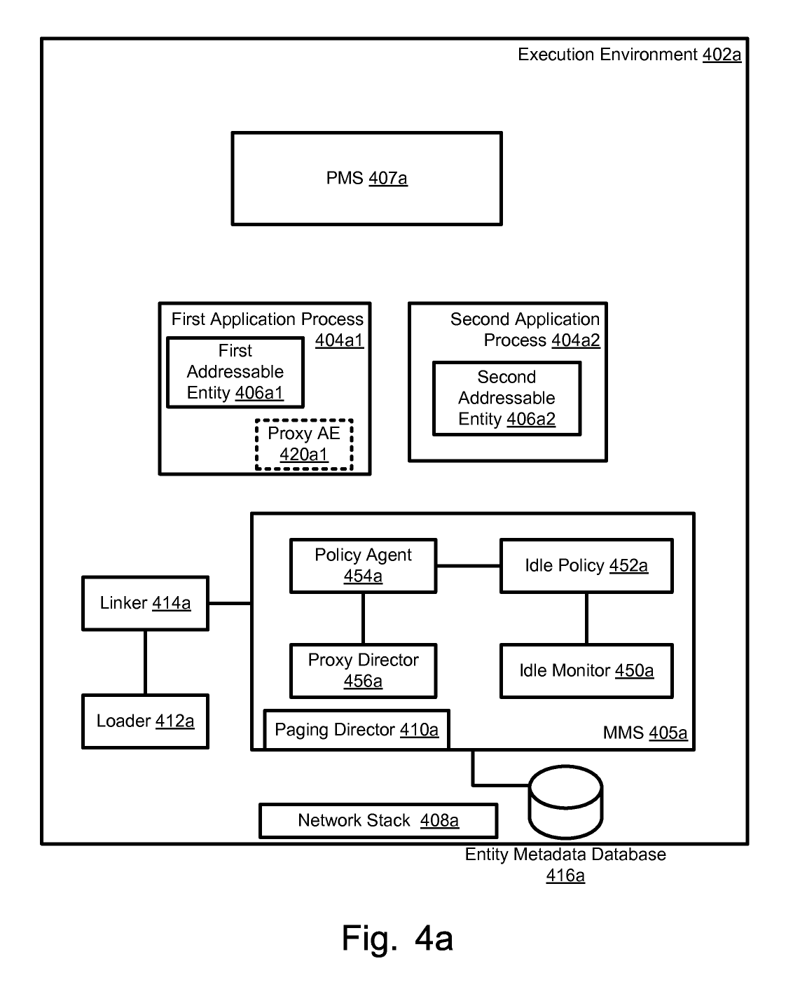

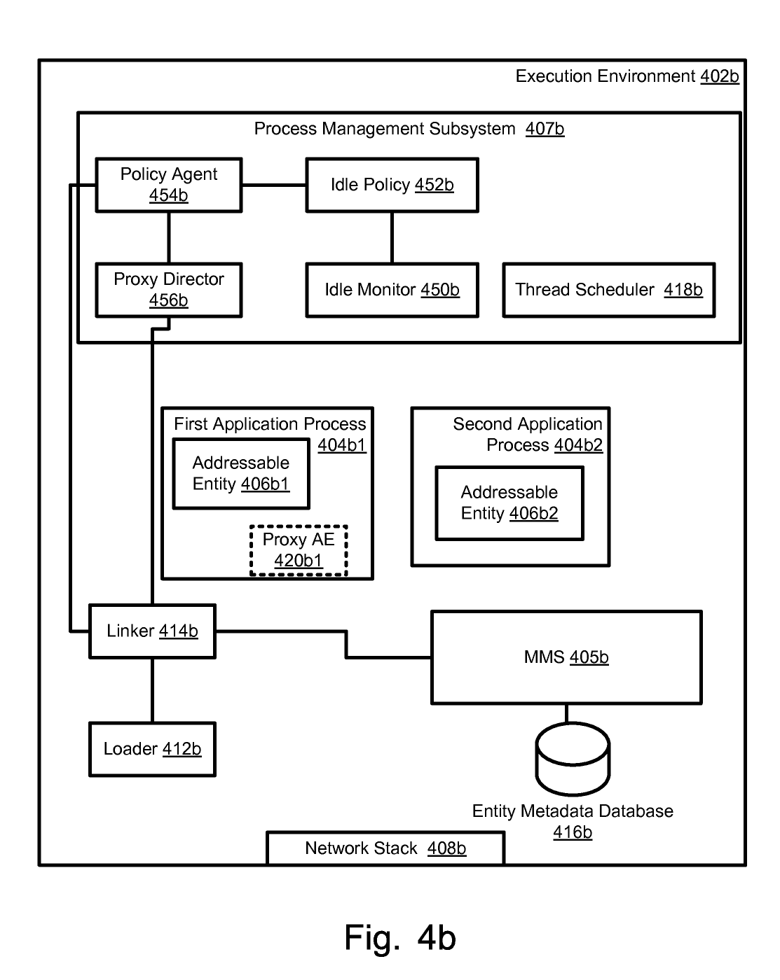

The components illustrated in FIG. 3 may be adapted for performing the method illustrated in FIG. 2 in a number of execution environments. Adaptations and analogs of the components illustrated in FIG. 3 for performing the method illustrated in FIG. 2 are described operating in exemplary execution environment 402a illustrated in FIG. 4a and exemplary execution environment 402b illustrated in FIG. 4b.

FIG. 1 illustrates key components of an exemplary device that may at least partially provide and/or otherwise be included in an exemplary execution environment, such as those illustrated in FIG. 4a and FIG. 4b. The components illustrated in FIG. 3, FIG. 4a and FIG. 4b may be included in or otherwise combined with the components of FIG. 1 to create a variety of arrangements of components according to the subject matter described herein.

Component identifiers including postfixes including letters and/or numbers in the figures are referred to collectively using the respective identifiers without the postfixes and with partial postfixes; and, in some cases are referred to generically across the figures in the same manner when the including description applies to more than one of the illustrated components.

FIG. 4a illustrates an arrangement of the components in FIG. 3 adapted to operate in a memory management subsystem (MMS) 405a in execution environment 402a. FIG. 4b illustrates an arrangement of the components in FIG. 3 adapted to operate in a process management subsystem (PMS) 407b in execution environment 402b.

The various adaptations described herein of the arrangement in FIG. 3 are not exhaustive. For example, those skilled in the art will see based on the description herein that arrangements of components for performing the method illustrated in FIG. 2 may be at least partially included in an application and at least partially external to a serviced application. Further, arrangements for performing the method illustrated in FIG. 2 may be distributed across more than one node and/or execution environment.

Execution environments 402, as illustrated in FIG. 4a and in FIG. 4b, may include and/or otherwise be provided by a device. The device may be a node operatively coupled to a network. FIG. 4a and FIG. 4b illustrate network stacks 408 configured for sending and receiving messages over a network, such as the Internet, via a network interface. Network stacks 408 may support a protocol suite, such as TCP/IP. FIG. 4a and FIG. 4b illustrate application processes 404 that may communicate with one or more other nodes via one or more application layer protocols.

The components of a user interface are generically referred to herein as user interface elements. More specifically, visual components of a user interface are referred to herein as visual interface elements. A visual interface element may be a visual component of a graphical user interface (GUI). Exemplary visual interface elements include windows, textboxes, various types of button controls including check boxes and radio buttons, sliders, list boxes, drop-down lists, spinners, various types of menus, toolbars, ribbons, combo boxes, tree views, grid views, navigation tabs, scrollbars, labels, tooltips, text in various fonts, balloons, and dialog boxes. An interface of an application process may include one or more of the exemplary elements listed. Those skilled in the art will understand that this list is not exhaustive. The terms visual representation, visual component, and visual interface element are used interchangeably in this document.

Other types of user interface elements include audio output components referred to as audio interface elements, tactile output components referred to a tactile interface elements, and the like.

A “user interface element handler” component, as the term is used in this document, includes a component configured to send information representing a program entity for presenting a user detectable representation of the program entity by an output device, such as a display. The user detectable representation is presented based on the sent information. The sent information is referred to herein as representation information.

Representation information includes data in one or more formats. Exemplary formats include image formats such as JPEG, video formats such as MP4, markup language data such as HTML and other XML-based markup, and/or instructions such as those defined by various script languages, byte code, and/or machine code. For example, a web page received by a browser may include HTML ECMAScript, image data, and/or byte code for presenting one or more user interface elements included in a user interface of an application process.

Components configured to send information representing one or more program entities for presenting particular types of output by particular types of output devices include visual interface element handlers, audio interface element handlers, tactile interface element handlers, and the like.

A program entity is an object included in and/or otherwise processed by an application or executable program component. A representation of a program entity may be represented and/or otherwise maintained in a presentation space.

As used in this document, the term presentation space refers to a storage region allocated and/or otherwise provided for storing some or all of an audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in a processor memory, a secondary storage, a memory of an output adapter device, and/or a storage medium of an output device. A screen of a display, for example, is a presentation space.

As used herein, the term “program” refers to any data representation that is and/or may be translated into a set of machine code instructions and associated program data, if any. A program or executable may include an application, a shared or non-shared library, and a system command. Program representations other than machine code include object code, byte code, and source code. Object code includes a set of instructions and/or data elements that either are prepared for linking prior to loading or are loaded into a processor memory. This definition includes machine code and virtual machine code, such as Java™ byte code.

As used herein, an addressable entity is a program entity specifiable in a source code language and accessible to an IPU via an address when stored in a processor memory in an executable representation. Examples of addressable entities include variables such as structures, constants including structured constants, functions, subroutines, methods, classes, anonymous scoped instruction sets, and individual instructions, which may be labeled. Strictly speaking, the addressable entity contains a value or an instruction, but it is not the value or the instruction. In some places, this document will use addressable entity in a manner that refers to content and/or a value of the entity. In these cases, the context will clearly indicate the intended meaning.

Addressable entities may have a number of corresponding representations. These representations include source code, object code, and any intermediate formats processed by an interpreter, compiler, linker, loader, or equivalent tool. Thus, terms such as addressable source code entity may be used in cases where the format is relevant and may be unclear from the context.

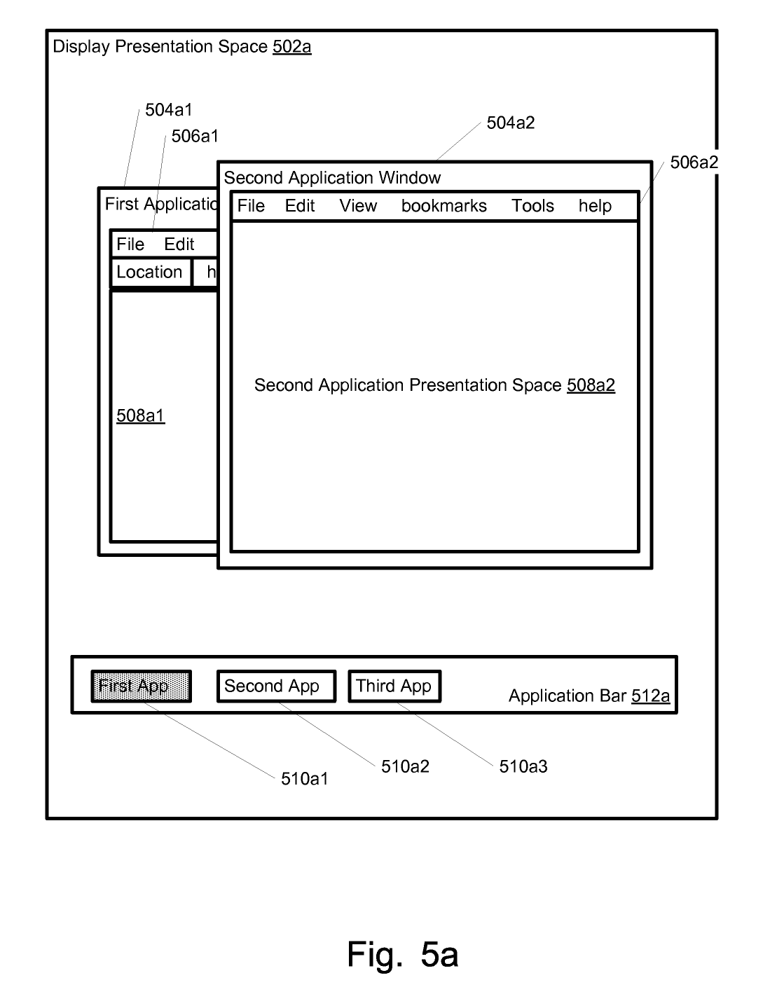

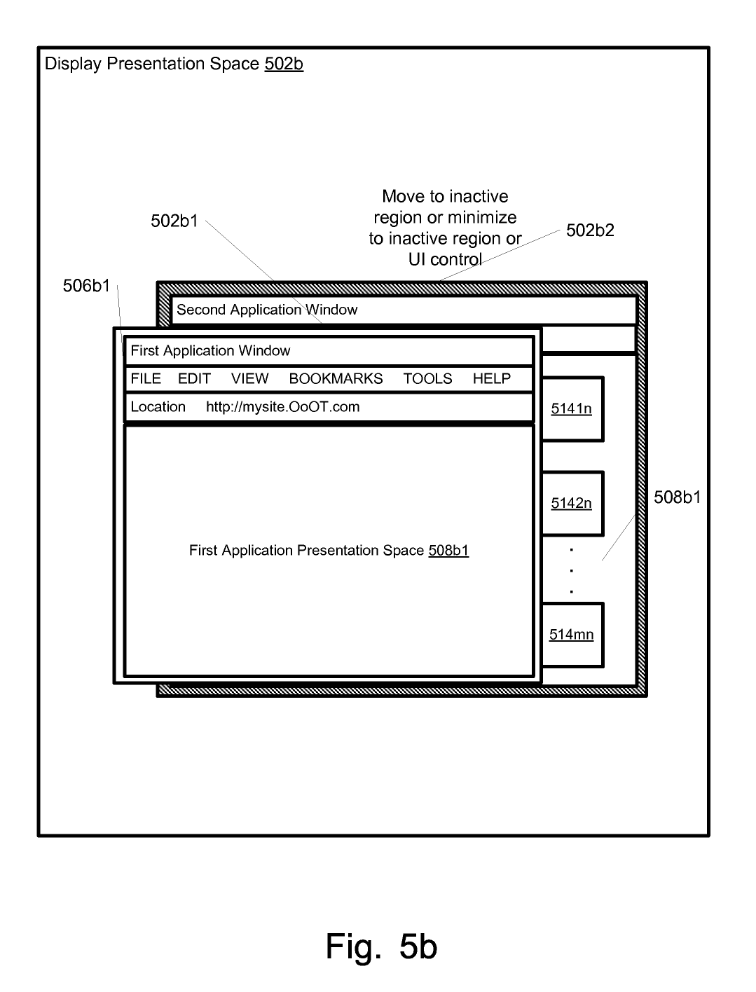

Application windows 504 in FIG. 5a and FIG. 5b illustrate a number of visual user interface elements commonly presented by application processes. One or more application windows 504 illustrated include menu bars 506 with menu controls for receiving user input to identify commands to perform. Application windows 504 also illustrate application presentation space 508 user interface elements providing respective presentation spaces for presenting one or more representations of application data that may include other visual components. An application window 504 may be part of a user interface of a browser process, mobile application process, desktop application process, or any process presenting a user interface. First application window 504a1 includes a first location bar 510a1 user interface component for presenting a universal resource identifier (URI) of a resource presented in first application presentation space 508a1. First application window 504a1 illustrates an exemplary browser window that may be presented by first application process 404a1 in FIG. 4a. First application presentation space 508a1 may include a user interface of a network application process provided by a remote node.

Various user interface elements of application processes 404 in FIG. 4a and FIG. 4b may be presented by one or more user interface element handler components (not shown) included in respective execution environments 402. A user interface handler component in a process may send representation information representing a visual interface element, such as menu bar 506a2 illustrated in FIG. 5a, to a GUI subsystem (not shown). A GUI subsystem may instruct a graphics subsystem (not shown) to draw the visual interface element in a region of a display presentation space 502, illustrated in FIG. 5a and in FIG. 5b, based on the representation information sent.

Input may be received corresponding to a user interface element via input drivers in respective execution environments 402 illustrated in FIG. 4a and FIG. 4b. For example, a user may move a mouse to move a pointer presented in a display presentation space 502 over a menu item identified in a menu bar 506 illustrated in FIG. 5a and FIG. 5b. The user may provide an input detected by the mouse. The detected input may be received by a GUI subsystem via an input driver as an operation or command indicator based on the association of the shared location of the pointer and the menu item in the display presentation space.

With reference to FIG. 2, block 250 illustrates the method includes detecting an idle period, for a first addressable entity in an application process presenting a user interface element via an output device, during which the first addressable entity, stored in a processor memory defined by an address space of an IPU, is not accessed by the IPU in the application process. Accordingly, a system for managing an idle computing component includes means for detecting an idle period, for a first addressable entity in an application process presenting a user interface element via an output device, during which the first addressable entity, stored in a processor memory defined by an address space of an IPU, is not accessed by the IPU in the application process. For example, as illustrated in FIG. 3, idle monitor component 350 is configured for detecting an idle period, for a first addressable entity in an application process presenting a user interface element via an output device, during which the first addressable entity, stored in a processor memory defined by an address space of an IPU, is not accessed by the IPU in the application process.

FIG. 4a and FIG. 4b illustrate idle monitor components 450 as adaptations and/or analogs of idle monitor component 350 in FIG. 3. One or more idle monitor components 450 operate in an execution environment 402. In FIG. 4a, idle monitor component 450a is illustrated operating in memory management subsystem (MMS) 405a in execution environment 402a. In FIG. 4b, idle monitor component 450b is illustrated operating in process management subsystem (PMS) 407b in execution environment 402b.

Exemplary addressable entities, such as first addressable entity 406a1 in FIG. 4a, include a function, a subroutine, a method in an object of specified class, an anonymous code block, and/or a labeled instruction. An addressable entity is specified in source code written in a programming language.

In an aspect, an idle monitor may detect an idle period for an addressable entity by receiving metadata identifying an address, in an address space, identifying a location, in a processor memory, including at least a portion of the addressable entity. For example, MMS 405a in FIG. 4a may receive metadata for an addressable entity, such as first addressable entity 406a1. First application window 504a1 in FIG. 5a illustrates a user interface element currently presented by first application process 404a1 via a display device in execution environment 402a. The metadata may identify an address in an address space of an IPU in execution environment 402a. The IPU may access the addressable entity in a processor memory location identified by the address. The IPU may access the location in the processor memory defined by the address space to execute an instruction in first addressable entity 406a1 stored at the location identified by the address. The instruction stored in the location identified by the metadata may be included in a sequence of instructions in a thread in first application process 404a1. When the IPU executes one or more of instructions in the sequence first addressable entity 406a1 may be accessed.

MMS 405a may configure first addressable entity 406a1, physical memory, and/or a component of MMS 405a to invoke activity monitor 450a in response to a detected access of the location identified by the metadata.

In an aspect, configuring a first addressable entity to invoke an activity monitor may include modifying one or more instructions in the first addressable entity and/or may include modifying a second addressable entity including an instruction for accessing the first addressable entity. Modifying the first addressable entity and/or modifying the second addressable entity may include modifying the first addressable entity and/or modifying the second addressable entity to generate an interrupt, send a notification indicating an access, and/or otherwise intercept an access to the first addressable entity. An idle period may be detected in response to and/or otherwise based on detecting a period during which no interrupts, notifications, and/or other indications of an access are detected.

For example, MMS 405a may modify first addressable entity 404a1 to invoke idle monitor component 450a when an access to first addressable entity 406a1 is detected. In one aspect, MMS 405 replaces and/or otherwise inserts a software interrupt instruction in an accessing addressable entity including a reference for accessing first addressable entity 406a1 and/or replaces and/or otherwise inserts a software interrupt instruction in first addressable entity 406a1 accessed by the IPU in execution environment 402a when first addressable entity 406a1 is accessed. Alternatively or additionally, an interrupt instruction may be inserted at a location accessed by the IPU after an addressable entity is accessed. Idle monitor component 450a may be configured as an interrupt handler for the software interrupt or may be invoked by an interrupt handler for the interrupt.

In another example, MMS 405a may configure idle monitor component 450a, based on metadata identifying a processor memory address of second addressable entity 406a2, as an interceptor for accesses to second addressable entity. For example, one or more instructions for accessing second addressable entity 406a2 in second application process 404a2 may be modified to access idle monitor component 450a before, after, and/or during an access of second addressable entity 406a2. Second application window 504a2 in FIG. 5a illustrates a user interface element currently presented by second application process 404a2 via a display device in execution environment 402a. An interceptor may be invoked to execute in the same thread as an accessed addressable entity and/or may be invoked via an interprocess communication mechanism such as a pipe, a message queue, an interrupt, and/or a shared location in a data storage medium.

Detecting an idle period, in another aspect, may include setting a physical memory device to generate a hardware interrupt in response to an access to a region of physical memory including an addressable entity, marking a page in a page table, and/or marking an instruction in a translation lookaside buffer (TLB). For example, paging director 410a in MMS 405a may set a bit for generating a hardware interrupt when the IPU in execution environment 402a accesses a location in a page in the processor memory defined by the address space for first application process 404a1 including an instruction in first addressable entity 406a1. Alternatively or additionally, MMS 405a may mark a page or other identifier of a region of the processor memory including an instruction in first addressable entity 406a1. Paging director 410a may detect a mark in response to a page-table miss and/or a TLB miss.

For example, a memory page may include a metadata location for marking the page. The mark may be defined to indicate the page includes a monitored addressable entity, such as first addressable entity 406a1 and/or second addressable entity 406a2. In response to detecting a marked page and/or other marked location, MMS 405a may locate one or more addressable entities to be monitored based on metadata for the addressable entities provided to MMS 405a by, for example, loader 412a, and/or linker 414a. MMS 405a may store metadata in processor memory and/or in secondary storage as illustrated by entity metadata database 416a. Once an addressable entity is located, MMS 405a may monitor access to the addressable entity as described in the previous paragraphs and/or via any other suitable mechanism for detecting an access to a specified location in the processor memory. MMS 405a may interoperate with loader 412a and/or linker 414a in configuring execution environment 402a for invoking activity monitor 450a in response to detecting an access of an addressable entity including one or more instructions.

In another aspect, detecting an idle period may include determining that an instruction in an addressable entity is included in a sequence of instructions in a thread in an application process; and detecting the idle period includes detecting a period during which no instruction in the sequence is accessed for executing.

For example, process management subsystem (PMS) 407b in FIG. 4b may receive metadata for an addressable entity, such as first addressable entity 406b1 included in first application process 404b1. The metadata may associate first addressable entity 406b1 with a first thread in first application process 404b1. First application window 504b1 in FIG. 5b illustrates a user interface element currently presented by first application process 404b1 via a display device in execution environment 402b. Thread scheduler 418b in PMS 407b may manage state transitions for one or more threads in one or more application processes. PMS 407b may maintain thread state information. Idle monitor component 450b may interoperate with MMS 407b to track thread state and thread state changes for one or more threads in an application process including an addressable entity over a period of time.

In an aspect, an application process may include a single thread. For example, first application process 404b1 may include a single thread. The thread includes a sequence of instructions including one or more instructions in first addressable entity 406b1. A period of time may be detected, for example, in response to one or more timer expirations. Idle monitor component 450b may detect a time period during which the thread is never in an executable state allowing the IPU in execution environment 402b to access an instruction in the thread. Idle monitor component 450b may detect the idle period in response to determining the first thread has not been in an executable state during the detected period based on the thread being the only thread in first application process 404b1.

Instead of or in addition to tracking thread states, detecting an idle period may include determining that no data is exchanged with a thread including a monitored addressable entity. For example, idle monitor component 450b may monitor interprocess communications with a thread including first addressable entity 406b1 in first application process 404b1 and/or may monitor communications, directly and/or indirectly, with one or more hardware components in execution environment 402b. Idle monitor component 450b may determine that a lack of data communicated over a period of time to and/or from the thread with other threads and/or hardware components indicates no instruction in first addressable entity 406b1 is accessed by the IPU in execution environment 402b during the time period. Idle monitor component 450b may detect data exchanges by monitoring one or more message queues, pipes, interrupts, and/or shared locations in one or more data storage media and/or one or more hardware registers. Data may be exchanged with a thread in execution environment 402 by a remote node operatively coupled to execution environment 402 via a network. Detecting an exchange of data with a thread may include detecting sending and/or receiving a message for exchanging data between the thread and the remote node. In an aspect, detecting the idle period includes at least one of receiving and not receiving a message via a network. Detecting and/or otherwise determining that a network message is exchanged with a thread may indicate that an addressable entity in the thread is active.

In still another aspect, metadata may indicate an addressable entity is accessed by an IPU in a hosting execution environment in response to receiving a message via a network. An idle monitor may monitor messages to detect an idle period for the addressable entity. Additionally or alternatively, metadata may identify that an addressable entity may send a message via a network when accessed for executing by an IPU in an including execution environment. An idle monitor may monitor messages to be transmitted via a network to detect an idle period. A sent and/or a received message may indicate an addressable entity is active. Other types of input and output may be analogously monitored by various adaptations of idle monitor component 350 in FIG. 3 in various aspects. Detecting an idle period may include detecting a period of time during which no messages are exchanged with an addressable entity via a network. This may be determined indirectly by detecting a period during which no messages are exchanged with a thread including the addressable entity.

In another aspect, detecting an idle period based on sending and/or receiving a message via a network may include receiving a message via a network indicating an addressable entity for detecting an idle period and/or metadata for detecting an idle period for an addressable entity. For example, configuration information identifying second addressable entity 406b2 in second application process 404b2 may be received from a configuration service and/or via a browser in a node remote from execution environment 402b interoperating with the configuration service (not shown) in execution environment 402b, for idle monitor component 450b.

While FIG. 4a illustrates an adaption of the arrangement in FIG. 3 operating in a memory management subsystem and FIG. 4b illustrates an adaption of the arrangement in FIG. 3 operating in a memory management subsystem, it will be clear to those skilled in the art based on the description herein that various adaptations of the arrangement in FIG. 3 in various aspects may operate in and/or may be distributed between or among various subsystems of a hosting execution environment. As described above some or all of an adaption of the arrangement in FIG. 3 may operate in a network subsystem, a storage subsystem, and/or a presentation subsystem, for example. Some or all of an adaptation of the arrangement in FIG. 3 may operate in an application process configured to perform the method illustrated in FIG. 2 for addressable entities in the application process.

An application process may include multiple of threads. Detecting an idle period may include determining that an addressable entity in an application process is not included in one or more of the threads in the process. For example, second addressable entity 406b2 in second application process 404b2 may be identified by PMS 407b as included in a first thread in second application process 404b2. An idle period may be detected for the first thread as described above. Second application process 404b2 may include one or more other threads, such as a second thread. Idle monitor component 450b and/or PMS 407b may determine based on metadata for second addressable entity 406b2, second application process 404b2, and/or the second thread that second addressable entity 406b2 is not included in the second thread. This may be determined for other threads, if any, in second application process 404b2. Idle monitor component 450b may detect an idle period for second addressable entity 406b2 in second application process 404b2, based on detecting the idle period for second addressable entity 404b2 with respect to the first thread in second application process 404b2 and based on determining that second addressable entity 406b2 is not included in the second thread and any other threads, if any. The second thread may have been in an executable state during the time period or not.

As described above, an application process may include multiple threads. Detecting an idle period may include determining that an addressable entity is included in sequences of instructions in respective multiple threads in a process and detecting a period during which no instruction in any of the sequences is accessed for executing.

For example, idle monitor component 450b may detect based on metadata for second application process 404b2, second addressable entity 406b2, and/or for one or more threads in second application process 404b2 that second addressable entity 406b2 is included in a plurality of the threads such as a first thread and a second thread. Idle monitor component 450b as described above may detect a period of time during which neither first thread nor the second thread is in an executable state. In response, idle monitor component 450b may detect an idle period for second addressable entity 406b2 in second application process 404b2. Idle monitor component 450b may determine any number of threads including an addressable entity in a process have not been in an executable state during any particular period of time.

In an aspect, detecting an idle period may include receiving an idle indication from an application process indicating an idle period for an addressable entity in the application process, indicating the addressable entity is to be monitored, and/or identifying information for detecting the idle period. As described above, some or all of an idle monitor may be included in an application process to detect an idle period for one or more addressable entities in the application process. An idle monitor in an application process may interoperate with an idle monitor such as idle monitor component 450b in FIG. 4b and/or idle monitor component 450a in FIG. 4a. Metadata identifying an addressable entity for monitoring may be communicated by an application process to an idle monitor either directly or indirectly.

In still another aspect, detecting an idle period for an addressable entity may include detecting an operational state of an including application process. For example, for a media player application process an idle monitor may receive information identifying whether the media player application is in a play state, a pause state, a rewind state, and/or a fast forward state over a detected period of time.

In various aspects, detecting an idle period may include setting a timer; detecting a timer expiration; and/or detecting an event identifying a start, an end, and/or a time during an idle period. For example, a timer component (not shown) may be set by idle monitor component 450, MMS 405, PMS 407, and/or some other component included in an execution environment 402 illustrated in FIG. 4a and in FIG. 4b. The timer has a start time and may be configured with specified duration. Idle monitor component 450 in FIG. 4a and FIG. 4b may detect an expiration of the timer, directly and/or indirectly via another component. Expiration of the timer may be defined to indicate the timer has not been reset during the duration in response to an access to an instruction in an addressable entity in an application process. A time period may be detected indirectly through detecting the occurrence of other events that bound and/or occur in a period of time. Detected time periods may the same duration and/or varying duration in various aspects.

Various adaptations of idle monitor component 350 in FIG. 3, such as idle monitor components 450 in FIG. 4a and FIG. 4b, in various aspects may detect periods measured based on various types of measures of time and may interoperate with various components for measuring time. Time may be measured in regular increments as is typical, but may also be measured by the occurrence of events that may be irregular over a given period as compared to time measured by a processor clock. For example, time may be measured in instructions executed by a processor, input events detected by one or more user input devices, and/or bytes received via from one or more network applications and/or from one or more data storage media.

Various adaptations and analogs of idle monitor component 350 in FIG. 3 may detect and/or identify an idle period based on an absolute measure of time. For example a period may be detected based on a timer expiration of a timer set with a specified duration in milliseconds, seconds, minutes, hours, days, and/or weeks. Alternatively or additionally, a period may be detected based on a relative measure of time, for example by counting and comparing events that occur in time for one addressable entity with events associated with another entity (addressable or not).

For example, idle monitor component 450a in FIG. 4a may detect inputs for first application window 504a1 in FIG. 5a presented by first application process 404a1. When an input is detected, a timer may be set with a specified duration. If the timer expires prior to detecting another input event, idle monitor component 450a may detect an idle period for an addressable entity in first application process 404a1. An idle period may include a period during which no user input is received corresponding to a user interface element presented by an application process.

A time period may be measured, for example, by counting user inputs, CPU cycles, or any suitable event. For example, disk I/O events may be counted to measure time among application processes in execution environment 402b. An idle monitor may be included in file system and/or an idle monitor, such as idle monitor component 450b, may interoperate with the file system directly or indirectly to detect periods measured in disk I/O events. Idle monitor component 450b may set a disk I/O based timer by providing a number of disk I/O events to count. The disk I/O timer expires when the number of disk I/O events specified is detected. For example, during a period of one thousand detected disk I/O events, idle monitor component 450b may determine that second addressable entity 406b2 in second application process 404b2 has not been accessed by the IPU in execution environment 402b.

Returning to FIG. 2, block 252 illustrates the method further includes determining a specified idle condition is met for the idle period. Accordingly, a system for managing an idle computing component includes means for determining a specified idle condition is met for the idle period. For example, as illustrated in FIG. 3, idle policy component 352 is configured for determining a specified idle condition is met for the idle period.

FIG. 4a and FIG. 4b illustrate idle policy components 452 as adaptations of and/or analogs of idle policy component 352 in FIG. 3. One or more idle policy components 452 operate in an execution environment 402. Execution environment 402a includes idle policy components 452a in its presentation subsystem in process management subsystem 405a. Execution environment 402b includes idle policy components 452b in its process management subsystem 407b.

In the various adaptations, determining that a specified idle condition is met may be based on a duration of a detected idle period. An idle condition may be based on a duration of an idle period, and/or an idle condition may be determined and/or selected based on a duration of an idle period.

For example, a measure of the duration of an idle period may be provided as input to idle policy component 452a in FIG. 4a for testing and/or otherwise evaluating an idle condition for first addressable entity 406a1 and/or second addressable entity 406a2. A variety of idle conditions may be tested in various aspects. For example, an idle condition may specify a threshold duration for testing whether a detected idle period duration matches and/or exceeds the threshold duration.

A threshold duration in an idle condition may be conditional. That is, an idle condition and/or the threshold duration may be based on a type of a user interface element presented by an application process, a task performed by an application process, a user, a group, a role, an attribute of a user interface element, a user detectable attribute of an application process, an input to an application process, an output of an application process, a message transmitted via a network, a measure of energy, a count of user interface elements in a presentation space, a count of active application processes, a relationship of a first application process to a second application process, a geospatial location, and/or an application operating in an application process.

An idle condition may be relative. In various aspects, an idle condition for an addressable entity may include a comparison based on information about another addressable entity. For example, idle policy component 452b in FIG. 4b may test an idle condition for a detected idle period for first addressable entity 406b1 that includes a comparison with, for example, information about user interaction with second application window 504b2 in FIG. 5b presented by second application process 404b2.

In another example, idle policy component 452a in FIG. 4a, may evaluate an idle condition that is met for first addressable entity 406a1 when both second addressable entity 406a2 is idle and the duration of the idle period of first addressable entity 406a1 exceeds the duration of the idle period of second addressable entity 406a2.

In FIG. 4a, idle policy component 452a may identify and/or evaluate one or more idle conditions based on a duration of an idle period specified for a particular application process, such as second application process 404a2. An idle condition may be configurable by a user and/or by another component. In another aspect, idle monitor component 450b in FIG. 4b may provide idle period information identifying a duration of a detected idle period to idle policy component 452b.

An idle period may have one or more durations. A particular duration may be measured based on one or more types of measurements. For example, idle monitor component 450a in FIG. 4a may measure a duration via interoperating with a processor clock and/or other clock device in execution environment 402a. Some or all of the same and/or different idle period may be measured in user input events detected as described above.

An idle condition may be based on one or more durations of various types of time periods. Exemplary types of time periods that may be at least partially included in an idle period include a period during which no user input is detected corresponding to one or more addressable entities, a period of time during which an application process visual user interface is minimized, a period of time during which no persistent data storage medium is accessed by an application process, a period of time during which no data is exchanged with an application process or a particular thread in an application process, a period time a user interface element presented by an application process is hidden, and/or a period during which a user interface element of an application process has not had input focus.

In an aspect, idle policy component 452a in FIG. 4a may be configured with a network identifier of a power management service (not shown) operating in a remote node. The power management service may maintain configured idle conditions for detecting idle addressable entities for detecting application processes using energy and other resources that are possibly being used unnecessarily. When idle policy component 452a receives idle period information from idle monitor component 450a, idle policy component 452a may send a message via network stack 408a and optionally via an application protocol layer (not shown) to retrieve an idle condition for testing, to retrieve a parameter for an idle condition, and/or to request power management service to at least partially evaluate an idle condition.

Various adaptations and/or analogs of idle monitor component 350 in FIG. 3 in various aspects may receive and/or determine whether an idle condition is met based on, for example, a user detectable attribute of an application process, a task performed by an application process, an input to an application process, an output of an application process, a user, a group, a role, an access privilege, a message received via a network, a measure of energy, a count of user interface elements, a count of active application processes, a relationship of an application process to another active application process, a geospatial location, and/or a current state of a transaction.

For example, determining whether an idle condition is met may include evaluating a measure of power or energy available in a battery in determining whether the condition is met. For example, second application process 404b2 in FIG. 4b performing an operation in a particular task may be associated with an idle condition including a longer threshold duration than first application process 404b1 performing an operation in another task. The threshold duration for each process may be determined and/or otherwise identified based on the respective tasks and the measure of power.

An idle condition may, for example, be identified and/or evaluated for an addressable entity based on a type of a user interface element, a type of the data processed by an addressable entity, an application process task, a user, a group, a role, and/or any other attribute accessible in an execution environment. For example, modal user interface elements may be associated with idle conditions that include relatively shorter threshold durations than idle conditions evaluated for application processes presenting non-modal user interface elements.

In an aspect, an addressable entity may be shared and/or otherwise included in more than one application process. Determining whether an idle condition for the addressable entity in a first application process for a detected idle period is met may include determining the idle period includes an idle period for the addressable entity in another application process. For example, first addressable entity 406b1 may be included in first application process 404b1 and in a third application process (not shown) in execution environment 402b. Idle monitor component 450b may detect a period of time during which first addressable entity 406b1 is not accessed for executing in either first application process 404b1 and the third application process by the IPU in execution environment 402b. Idle monitor 450b may be invoked for determining whether an idle condition is met for the addressable entity.

Returning to FIG. 2, block 254 illustrates the method yet further includes in response to determining the idle condition is met, removing the first addressable entity from the processor memory. Accordingly, a system for managing an idle computing component includes means for in response to determining the idle condition is met, removing the first addressable entity from the processor memory. For example, as illustrated in FIG. 3, policy agent component 354 is configured for in response to determining the idle condition is met, removing the first addressable entity from the processor memory.

FIG. 4a and FIG. 4b illustrate policy agent components 454 as adaptations and/or analogs of policy agent component 354 in FIG. 3. One or more policy agent components 454 operate in an execution environment 402. In FIG. 4a, policy agent component 454a is illustrated operating in memory management subsystem 405a in execution environment 402a. In FIG. 4b, policy agent component 454b is illustrated operating in process management subsystem 407b in execution environment 402b.

In FIG. 4a and in FIG. 4b, policy agent component 454 may receive addressable entity information identifying an addressable entity in an application process to remove the addressable entity from the processor memory of the application process. Addressable entity information may be provided by idle policy component 452, idle monitor component 450, MMS 405, PMS 407 or another component depending on a particular execution environment and adaption of the arrangement in FIG. 3. Removing an addressable entity from a processor memory may include removing and/or otherwise modifying a reference in the processor memory to the addressable entity, overwriting some or all of a location in the processor memory storing some or all of the addressable entity, and/or adding an address to a location in the processor memory storing some or all of the addressable entity to a free list identifying free memory locations.

In an aspect, the method in FIG. 2 may include sending, in response to determining that an idle condition is met for an idle time period, idle information to present a user detectable idle indication for the addressable entity. Accordingly, a system for managing an idle computing component includes means for sending, in response to determining that an idle condition is met for an idle time period, idle information to present a user detectable idle indication for the addressable entity. For example, FIG. 3 illustrates policy agent component 354 configured for sending, in response to determining that an idle condition is met for an idle time period, idle information to present a user detectable idle indication for the addressable entity.

An idle indication is presented by sending idle information to a component of a presentation subsystem and/or output device to present to a user. Sending may be performed by any suitable mechanism including an invocation mechanism, such as function and/or method call; an interprocess communication mechanism, such as a pipe, a semaphore, a shared data area, and/or a message queue; and/or a network communication, such as an HTTP request and/or an asynchronous message.

In an aspect policy agent component 454a, in FIG. 4a, may include a user interface element handler for presenting an idle indication. The user interface element handler in policy agent component 454a may send idle information by invoking a GUI subsystem in execution environment 402a to present an idle indication by via the same output as the including application process presents a user interface element and/or via another output device. Policy agent component 454a in FIG. 4a may send color information to present first app icon 510a1 representing first application window 504a1 with a different color pattern as other app icons 510a presented in application bar 512a. Idle information for changing the color pattern may be sent to the GUI subsystem to present an indication that first application process 404a1 includes an idle addressable entity.

Alternatively or additionally, policy agent component 454b in FIG. 4b may interoperate with a user interface handler component presenting some or all of a user interface element in an including application process to change an attribute of the user interface element as an idle indication for the addressable entity. For example, policy agent component 454b may send color information to present a user interface element in black and white rather than color as user interface elements normally are presented. Idle information may include information for changing a border thickness of at least a portion of a user interface element as an idle indication for an addressable entity. FIG. 5b illustrates second application window 504b2 presented in a darkened background in a region of display presentation space 502b illustrating an exemplary idle indication.

In various aspects a user detectable indication may include a representation of time, such as a frozen clock face or an operating clock face showing a current idle duration; a change in an attribute of an idle user interface element, such as z-order, a level of transparency, a location in a presentation space, a size, a shape, and/or input focus state; and/or a new user interface element, such as a pop-up message and/or a fly-over user interface element. A location for presenting an idle indication may be based on a location of a user interface element presented by an application process including an idle addressable entity and/or may be a location determined prior to detecting the idle addressable entity.

A user detectable indication that an addressable entity in an application process is idle may be presented on a same output device as the idle user interface element and/or a different output device. The indication may be presented via a visual output device, an audio output device, a tactile output device, and another type of output device.

A user detectable indication that an addressable entity is idle may be presented for a specified duration of time, until a specified event is detected, and/or may include a pattern of changes presented to a user. For example, an indication may be presented until a user input is detected that corresponds to the indication forcing a user to acknowledge the indication to make it disappear.

The method in FIG. 2 may additionally include configuring a proxy addressable entity including an instruction stored in the processor memory for accessing in instead of the removed first addressable entity. Accordingly, a system for managing an idle computing component includes means for configuring a proxy addressable entity including an instruction stored in the processor memory for accessing in instead of the removed first addressable entity. For example, FIG. 3 illustrates, as an optional component in the arrangement, proxy director component 356 configured for configuring a proxy addressable entity including an instruction stored in the processor memory for accessing in instead of the removed first addressable entity.

FIG. 4 illustrates proxy director component 456 as an adaptation and/or analog of proxy director component 356 optionally included in the arrangement of components in FIG. 3. One or more proxy director components 456 operate in an execution environment 402. In FIG. 4a, proxy director component 456a is illustrated operating in MMS 405a in execution environment 402a. In FIG. 4b, proxy director component 456b is illustrated operating in PMS 407b in execution environment 402b.

Configuring a proxy addressable entity may include identifying an accessing addressable entity including a reference to the idle addressable entity and modifying the reference to access the proxy addressable entity. For example, proxy director component 456a in FIG. 4a may receive proxy information identifying proxy addressable entity (proxy AE) 420a1 and one or more references to the location where first addressable entity 406a1 is stored before removal and/or was stored prior to and during removal in the processor memory of first application process 404a1. Proxy addressable entity 420a1 may be invoked in the same manner as the addressable entity it replaces, first addressable entity 404a1. Proxy director component 456a may interoperate with linker 414a, loader 412a, and/or MMS 405a in configuring proxy addressable entity 420a1.

In another aspect, configuring a proxy addressable entity may include storing some or all of the proxy addressable entity in a location in the processor memory from which some or all of the idle addressable entity was removed. For example, proxy director component 456b in FIG. 4b may load proxy addressable entity into the processor memory of first application process 404b1 from a code library stored in a persistent data storage medium, such as a disk drive. Some or all of proxy addressable entity 429b1 may be stored in a location where some or all of first addressable entity 406b1 was stored prior to removal by policy agent component 454b. Proxy director component 456b may interoperate with loader 412b to load proxy addressable entity 420b1. In one aspect, no references to first addressable entity 406b1 are updated when an initial instruction for accessing proxy addressable entity 420b1 is accessible via current reference(s) to first addressable entity 406b1 prior to removal. In other aspects, one or more reference may be updated as described above.

In various aspects, a proxy addressable entity may perform one or more operations when accessed for executing by an IPU. Exemplary operations include terminating an including application process, presenting a user interface element via an output device to a user, writing a record to a log, sending a message via a network, restoring the idle addressable entity in the including application process, and/or invoking the restored addressable entity.

In an aspect, invoking a restored addressable entity includes loading the addressable entity into the processor memory of the including application process from a data storage medium not included in the address space of the IPU defining the processor memory. In an aspect, the restored addressable entity may be initialized without regard for the state of the addressable entity prior to removal. For example, first addressable entity 406b1 may be a function or method defined to process one or more instance variables defined in source code specifying the addressable entity. Proxy addressable entity 420b1 may instruct loader 412b to load a machine code representation of first addressable entity 406b1. Proxy addressable entity 420b1 may instruct linker 414b to redirect one or more references to the proxy addressable entity to the loaded machine code representation and/or may access the loaded first addressable entity 406b1 on behalf of an accessing addressable entity.

In an aspect, configuring a proxy addressable entity may include storing a representation of the state, prior to removing, of the removed addressable entity in a data storage medium. In the aspect, invoking a restored addressable entity includes detecting an access to the proxy addressable entity. In response to detecting access to the proxy addressable entity, loading the removed addressable entity into the processor memory of the including application process as described above, and configuring the state of the loaded addressable entity based on the stored representation of the state. For example, first addressable entity 406a1 in FIG. 4a may be a function or method that stored information indicating a state for first addressable entity 406a1. Proxy addressable entity 420a1 may instruct loader 412a to load a machine code representation of first addressable entity 406a1. Proxy addressable entity may restore the value of the stored information indicating a state from the representation of the state. Proxy addressable entity 420a1 may instruct linker 414a to redirect one or more references to proxy addressable entity 420a1 to the loaded machine code representation and/or may access the loaded first addressable entity 406a1 on behalf of an accessing addressable entity.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used herein, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable medium includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating any non-claimed element is essential to the practice of the subject matter as claimed.

I claim:

1. A method for managing an idle computing component, the method comprising:
detecting an idle period, for a first addressable entity in an application process presenting a user interface element via an output device, during which the first addressable entity, stored in a processor memory defined by an address space of an IPU, is not accessed by the IPU in the application process;
determining a specified idle condition is met for the idle period; and
in response to determining the idle condition is met, removing the first addressable entity from the processor memory.

2. The method of claim 1 wherein the first addressable entity includes at least one of a function, a subroutine, a method in an object of specified class, an anonymous code block, and/or a labeled instruction specified in source code written in a programming language.

3. The method of claim 1 wherein detecting the idle period includes receiving metadata identifying at least one of an address of a location in the in the processor memory including at least a portion of the first addressable entity, a thread in the application process including the addressable entity, and a resource included in an access of the first addressable entity.

4. The method of claim 3 wherein detecting the idle period comprises:
configuring, for providing an indication identifying an access of the first addressable entity by the IPU and based on the received metadata, at least one of the first addressable entity, a second addressable included in an access of the first addressable entity, a hardware component included in an access of the first addressable entity, a memory subsystem, a process management subsystem, and a component included in accessing a resource included in an access of the first addressable entity;
detecting a no-indication period during which no indication identifying an access is received; and
detecting the idle period based on detecting the no-indication period.

5. The method of claim 3 wherein detecting the idle period comprises:
determining, based on the received metadata, that the first addressable entity is included in a first thread in the application process; and
detecting the idle period includes detecting a period during which the thread is never in an executable state.

6. The method of claim 5 wherein the first thread is the only thread in the application process.

7. The method of claim 5 wherein the application process includes a second thread and the method further comprises determining based on the received metadata that the first addressable entity is not included in the second thread.

8. The method of claim 1 wherein detecting the idle period includes at least one of determining that no data is exchanged with a thread included in the application process, detecting the idle period includes at least one of receiving and not receiving a message via a network, and detecting an operational state of the application process.

9. The method of claim 1 wherein detecting the idle period includes at least one of setting a timer; detecting a timer expiration; and detecting an event identifying at least one of a start, an end, and a time during the idle period.

10. The method claim 1 wherein detecting the idle period includes measuring at least a portion a duration of the idle period based on detecting events that occur irregularly compared to the duration as measured by a processor clock.

11. The method claim 1 wherein detecting the idle period includes measuring at least a portion a duration of the idle period based on at least one of a processor clock, a count of input events, a count of instructions executed by a processor, a count of bytes, and a count of network messages.

12. The method of claim 1 wherein the idle period is detected based on a relative measure of time.

13. The method of claim 1 wherein determining the idle condition is met includes determining the idle condition is met based on a duration of the idle period, a type of the user interface element, a task performed by the application process, a user, a group, a role, an attribute of the user interface element, a user detectable attribute of the application process, an input to another application process, an output of another application process, a message transmitted via a network, a measure of energy, a count of user interface elements in a presentation space, a count of active application processes, a relationship of the application process to another application process, a geospatial location, and an application operating in the application process.

14. The method of claim 1 wherein determining the idle condition is met includes evaluating the idle condition based on a comparison based on information about another addressable entity.

15. The method of claim 1 wherein the idle period at least partially includes a period during which at least one of no user input is detected corresponding to the user interface element, the user interface element at least one of includes and is included in a user interface element that is minimized, no persistent storage medium is accessed by the application process, no data is exchanged between the application process and a remote node via a network, at least a portion of the user interface element is hidden, and the user interface element has not had input focus.

16. The method of claim 1 wherein determining that the idle condition is met includes evaluating the idle condition based on a measure of energy available in a battery.

17. The method of claim 1 wherein removing the first addressable entity includes at least one of modifying a reference to the first addressable entity in a second addressable entity, overwriting a location in the processor memory including at least a portion of the first addressable entity, adding an address of a location in processor memory of at least a portion of the first addressable entity to a free list identifying free memory locations.

18. The method of claim 1 further including sending, in response to determining the idle condition is met, idle information to present a user detectable idle indication for the first addressable entity via an output device.

19. The method of claim 1 wherein the idle condition includes at least one of a representation of measure of time, a particular z-order, a relative z-order, a level of transparency, a size, a shape, a color, a font, an input focus state, and a pattern of presentation.

20. The method of claim 1 wherein a location for presenting the idle indication is based on at least one of a location of the user interface element and a pre-specified location.

21. The method of claim 1 wherein the idle condition is presented via at least one of the output device and another output device.

22. The method of claim 1 wherein at least one of the output device and the another output devices includes at least one of a visual output device, an audio output device, a tactile output device, and another type of output device.

23. The method of claim 1 further comprises configuring a proxy addressable entity to be accessed in place of the removed first addressable entity.

24. The method of claim 23 wherein configuring the proxy addressable entity comprises:
identifying a second addressable entity including a reference to the first addressable entity; and
modifying the reference to access the proxy addressable entity.

25. The method of claim 23 wherein configuring the proxy addressable entity includes storing at least a portion of the proxy addressable entity in a storage location including at least a portion of the first addressable entity.

26. The method of claim 23 wherein the proxy addressable entity is configured for at least one of terminating the application process, presenting a user interface element via an output device to a user, writing a record to a log, sending a message via a network, and providing for invoking the restored first addressable entity.

27. The method of claim 23 wherein configuring the proxy addressable entity further comprises:
storing a representation of the current state of the addressable entity, prior to the removing, in a data storage medium;
detecting an access to the proxy addressable entity;
loading the first addressable entity into the processor memory;
configuring the state of the first addressable entity based on the stored representation of the current state; and
providing for invoking the loaded first addressable entity.

28. A system for managing an idle computing component, the system comprising:
an execution environment including an instruction processing unit configured to process an instruction included in at least one of an idle monitor component, an idle policy component, and a policy agent component;
the idle monitor component configured for detecting an idle period, for a first addressable entity in an application process presenting a user interface element via an output device, during which the first addressable entity, stored in a processor memory defined by an address space of an IPU, is not accessed by the IPU in the application process;
the idle policy component configured for determining a specified idle condition is met for the idle period; and
the policy agent component configured for in response to determining the idle condition is met, removing the first addressable entity from the processor memory

29. A computer readable medium embodying a computer program, executable by a machine, for managing an idle computing component, the computer program comprising executable instructions for:
detecting an idle period, for a first addressable entity in an application process presenting a user interface element via an output device, during which the first addressable entity, stored in a processor memory defined by an address space of an IPU, is not accessed by the IPU in the application process;
determining a specified idle condition is met for the idle period; and
in response to determining the idle condition is met, removing the first addressable entity from the processor memory.
